(19) United States
(12) Patent Application Publication
(10) Pub. No.: US 2026/0221673 A1
(43) Pub. Date: Jul. 30, 2026

(54) TERMINAL BASE

(71) Applicant: SUMITOMO WIRING SYSTEMS, LTD., Mie (JP)

(72) Inventor: Ken KINOSHITA, Mie (JP)

(21) Appl. No.: 19/460,550

(22) Filed: Jan. 27, 2026

(30) Foreign Application Priority Data
Jan. 30, 2025 (JP) 2025-013755

(51) Int. Cl. H01R 4/30; H01R 4/34; H01R 25/16

(52) U.S. Cl. CPC H01R 4/304; H01R 4/34; H01R 25/162

(57) ABSTRACT

A terminal base includes: a plate-shaped busbar that includes an insertion hole through which a bolt is to be inserted and that is to be fastened and connected to a counterpart terminal with the bolt; a housing for holding the busbar; a nut for fastening the busbar and the counterpart terminal to each other together with the bolt by the bolt being screwed to the nut; and a tubular collar that is fixed to the nut and that is attached to the insertion hole together with the nut. The nut and the collar are configured to be capable of being moved in the axis-orthogonal direction by being fixed to each other in the insertion hole with the busbar being sandwiched therebetween in the thickness direction.

### CROSS-REFERENCE TO RELATED APPLICATIONS

This application is based on and claims priority from Japanese Patent Application No. 2025-013755, filed on January 30, 2025, with the Japan Patent Office, the disclosure of which is incorporated herein in its entirety by reference.

### TECHNICAL FIELD

The present disclosure relates to a terminal base.

### BACKGROUND

For example, a terminal base described in JP 2015-026517 A includes a housing having a nut press-fit portion into which a nut is press-fitted, and a plate-shaped busbar disposed on the upper side of the nut press-fit portion. The busbar abuts against the upper surface of the nut that is press-fitted into and fixed to the nut press-fit portion. The busbar and a counterpart terminal are fastened to each other by a bolt being screwed to this nut.

### SUMMARY

In the terminal base as described above, the nut is fixed to the nut press-fit portion of the housing, and therefore, there is a risk that locational shifting in an axis-orthogonal direction occurs between the busbar and the nut due to manufacturing tolerances and attachment tolerances. When the locational shifting in the axis-orthogonal direction occurs between the busbar and the nut, there is a risk that poor attachment occurs, that is, the busbar and the counterpart terminal cannot be fastened to each other with a bolt.

It is an object of the present disclosure to provide a terminal base capable of suppressing occurrence of poor attachment when attaching a busbar and a counterpart terminal to each other.

A terminal base of the present disclosure includes: a plate-shaped busbar that includes an insertion hole through which a bolt is to be inserted and that is to be fastened and connected to a counterpart terminal with the bolt; a housing for holding the busbar; a nut for fastening the busbar and the counterpart terminal to each other together with the bolt by the bolt being screwed to the nut; and a tubular collar that is fixed to the nut and that is attached to the insertion hole together with the nut, wherein the nut and the collar are configured to be capable of being moved in an axis-orthogonal direction by being fixed to each other in the insertion hole with the busbar being sandwiched therebetween in a thickness direction.

With the terminal base of the present disclosure, it is possible to suppress occurrence of poor attachment when attaching a busbar and a counterpart terminal to each other.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view including a portion of a terminal base of an embodiment.

FIG. 2 is a plan view illustrating a portion of the terminal base of the embodiment.

FIG. 3 is a cross-sectional view taken along line 3-3 in FIG. 2.

FIG. 4 is an exploded perspective view of the terminal base of the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, aspects of the present disclosure will be listed and described.

1A terminal base of the present disclosure includes: a plate-shaped busbar that includes an insertion hole through which a bolt is to be inserted and that is to be fastened and connected to a counterpart terminal with the bolt; a housing for holding the busbar; a nut for fastening the busbar and the counterpart terminal to each other together with the bolt by the bolt being screwed to the nut; and a tubular collar that is fixed to the nut and that is attached to the insertion hole together with the nut, wherein the nut and the collar are configured to be capable of being moved in an axis-orthogonal direction by being fixed to each other in the insertion hole with the busbar being sandwiched therebetween in a thickness direction.

With this configuration, the movement of the nut attached to the insertion hole of the busbar via the collar in the axis-orthogonal direction is allowed in a state in which the busbar has not been fastened to the counterpart terminal with the bolt yet. Accordingly, the manufacturing tolerances and the attachment tolerances can be absorbed due to the movement of the nut in the axis-orthogonal direction, thus making it possible to suppress occurrence of poor attachment, that is, a failure to fasten the busbar and the counterpart terminal to each other with the bolt.

2 The terminal base according to 1 above may have a configuration in which the nut includes a nut main body to which the bolt is to be screwed, and a first flange portion extending outward in a radial direction from the nut main body, the collar includes a fixation portion fixed to the nut, and a second flange portion that extends outward in the radial direction from the fixation portion and that faces the first flange portion in an axial direction, and a portion of the busbar enters between the first flange portion and the second flange portion.

With this configuration, the movement of the nut in the axis-orthogonal direction is allowed, while dislodgment of the nut from the insertion hole can be prevented by the first flange portion of the nut and the second flange portion of the collar.

3 The terminal base according to 2 above may have a configuration in which an outer diameter of the first flange portion is larger than an outer diameter of the second flange portion.

With this configuration, the outer diameter of the second flange portion of the collar is reduced, while the overlap allowance of the nut against the busbar can be increased by increasing the outer diameter of the first flange portion of the nut.

4 The terminal base according to 2 or 3 above may have a configuration in which the busbar includes a first surface to be in contact with the counterpart terminal, and a second surface that is a surface on a side opposite to the first surface and that is in contact with the nut, the insertion hole passes through the busbar from the first surface to the second surface, the insertion hole includes a step portion provided at an intermediate position in an axial direction of the insertion hole, a first inner diameter portion provided near the first surface relative to the step portion, and the second inner diameter portion that is provided near the second surface relative to the step portion and that has a diameter smaller than that of the first inner diameter portion, the second flange portion is disposed inside the first inner diameter portion, and the second inner diameter portion enters between the first flange portion and the second flange portion.

With this configuration, it is possible to achieve a configuration in which the collar is disposed inside the insertion hole, while dislodgment of the nut and the collar from the insertion hole is prevented.

5 The terminal base according to 4 above may have a configuration in which in a state in which the busbar and the counterpart terminal are fastened to each other with the bolt and the nut, the entire second flange portion is located inside the first inner diameter portion in an axial direction.

With this configuration, the collar does not protrude from the first surface of the busbar even in a state in which the busbar and the counterpart terminal are fastened to each other, thus making it possible to favorably fastening the busbar and the counterpart terminal to each other.

6 The terminal base according to any one of 1 to 5 above may have a configuration in which the collar includes a locking portion, and the insertion hole includes a rotation restriction portion locked to the locking portion in a circumferential direction.

With this configuration, the rotation of the collar and the nut can be suppressed during the bolt fastening, thus making it possible to improve the attachability of the bolt.

7 The terminal base according to any one of 1 to 6 above may have a configuration in which the nut and the collar are fixed to each other through screw-fitting.

With this configuration, the nut and the collar can be easily fixed to each other through screw-fitting.

8 The terminal base according to any one of 1 to 7 above may have a configuration in which the nut and the collar are fixed to each other through press-fitting.

With this configuration, the nut and the collar can be easily fixed to each other through press-fitting.

### Details of Embodiments of the Present Disclosure

The following describes specific examples of a terminal base of the present disclosure with reference to the drawings. A portion of the configuration may be exaggerated or simplified for illustrative purposes in the diagrams. In addition, the ratios between the dimensions of portions shown in the diagrams may be different from each other. The term "orthogonal" as used herein encompasses not only "precisely orthogonal" but also "substantially orthogonal", as long as the functions and effects of the embodiment are exhibited.

The term "tubular" as used in the description of this specification means not only the shape of a circumferential wall that is continuously formed over the entire circumference thereof in the circumferential direction but also a tubular shape formed by a plurality of combined parts and a shape such as a C-shape in which a portion in the circumferential direction thereof includes a notch or the like. The outer circumference of the "tubular" shape may have a circular shape, an elliptical shape, and a polygonal shape with angular or rounded corners, but there is no limitation to these shapes. The "tubular" shape is a shape having a through hole in a plan view, and encompasses a tubular shape in which the outer circumferential shape thereof is the same as the inner circumferential shape of the through hole, and a tubular shape in which the outer circumferential shape thereof is different from the inner circumferential shape of the through hole. The "tubular" shape encompasses a tubular shape having a predetermined length in an axial direction in which the central axis passing through the center of the through hole extends, and there is no limitation on the length. The term "facing" as used herein means that surfaces or members are positioned so as to be opposed to each other, and encompasses a case where surfaces or members are positioned such that their entireties are opposed to each other as well as a case where surfaces or members are positioned such that their portions are opposed to each other. The term "facing" as used herein encompasses both a case where a member separate from the two portions is provided between the two portions and a case where nothing is provided between the two portions. The terms "first", "second", and the like as used herein are used simply to distinguish objects from each other and are not intended to rank the objects. The present invention is not limited to these embodiments and is defined by the scope of the appended claims, and all changes that fall within the same essential spirit as the scope of the claims are intended to be included therein.

### Configuration of Terminal Base 10

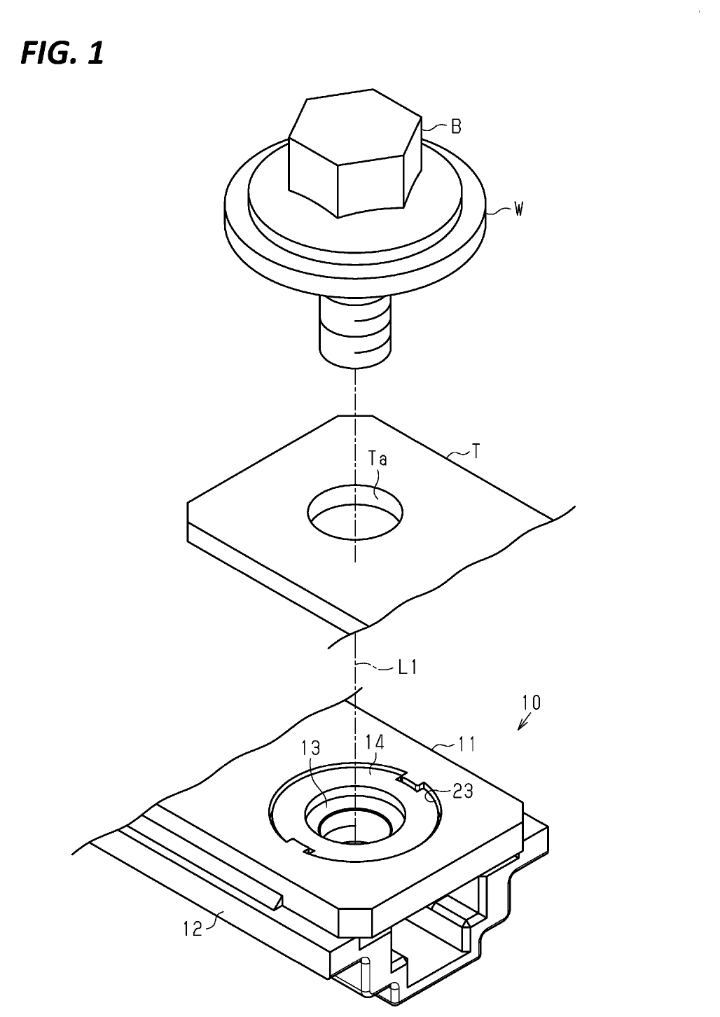

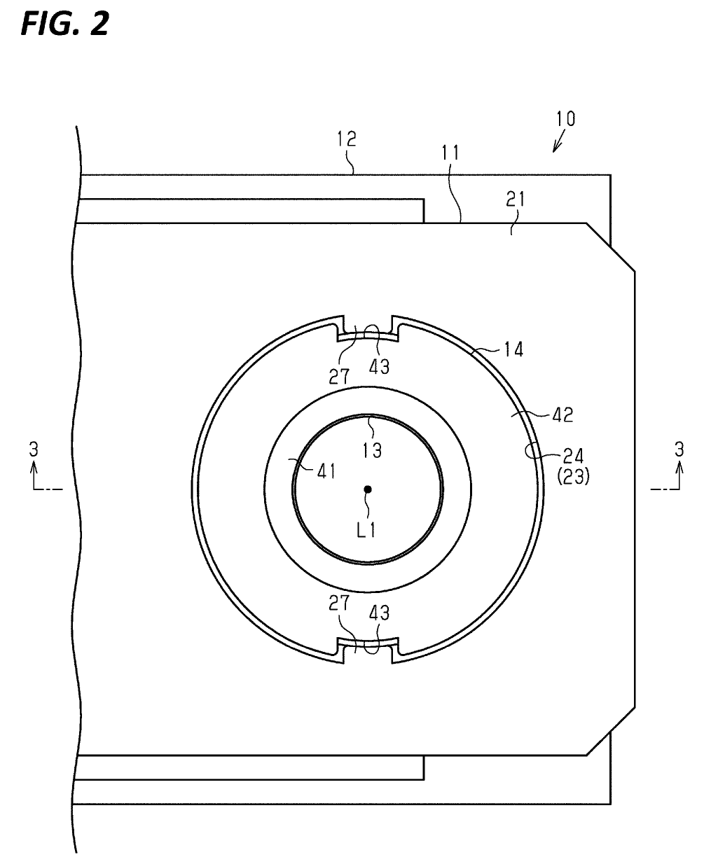

A terminal base 10 of this embodiment shown in FIGS. 1 and 2 is, for example, to be attached to an in-vehicle apparatus or the like (not illustrated). Note that in the diagrams, only a portion of the terminal base 10 that is to be fastened to a counterpart terminal T with a bolt is shown for illustrative purposes. The terminal base 10 includes a plate-shaped busbar 11, a housing 12 for holding the busbar 11, a nut 13 to which a bolt B is to be screwed, and a tubular collar 14.

The busbar 11 is made of a conductive material and has a flat plate shape. The busbar 11 is made of, for example, a metal material such as copper, a copper alloy, aluminum, an aluminum alloy, or stainless steel. The housing 12 is made of, for example, an insulator such as a synthetic resin. The busbar 11 may be configured to be individually attached to the housing 12 or may be integrally formed with the housing 12 through insert molding or the like. The collar 14 is fixed to the nut 13 and is attached to an insertion hole 23 (which will be described below) of the busbar 11 together with the nut 13. The busbar 11 is to be fastened to the counterpart terminal T with the bolt B and the nut 13. For example, a washer W is to be interposed between the head of the bolt B and the counterpart terminal T.

The counterpart terminal T is, for example, a harness-side terminal included in the in-vehicle apparatus. The counterpart terminal T is formed in, for example, a flat plate shape. The counterpart terminal T is made of, for example, a metal material such as copper, a copper alloy, aluminum, an aluminum alloy, or stainless steel. The counterpart terminal T is provided with a terminal-side insertion hole Ta through which the bolt B is to be inserted.

### Configuration of Busbar 11

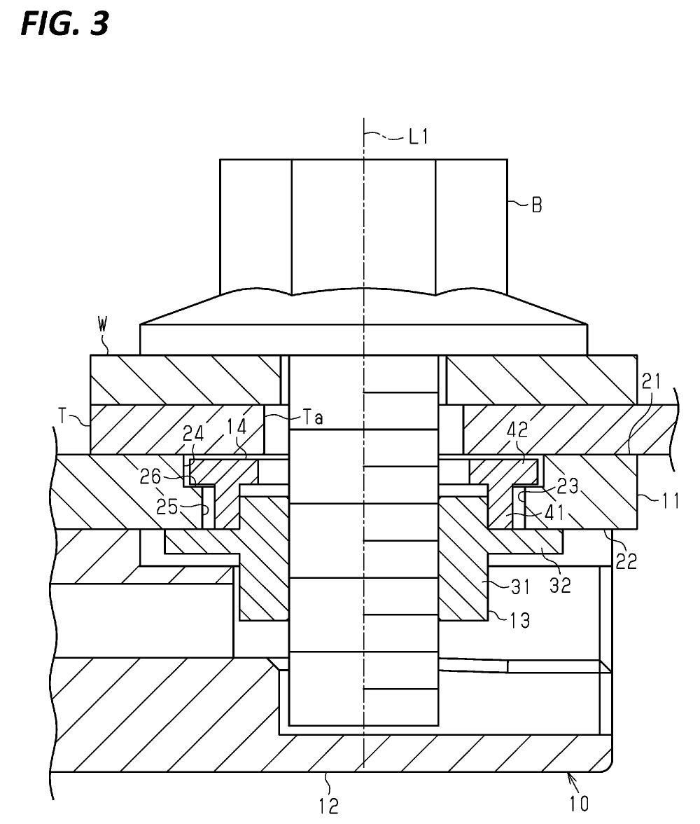

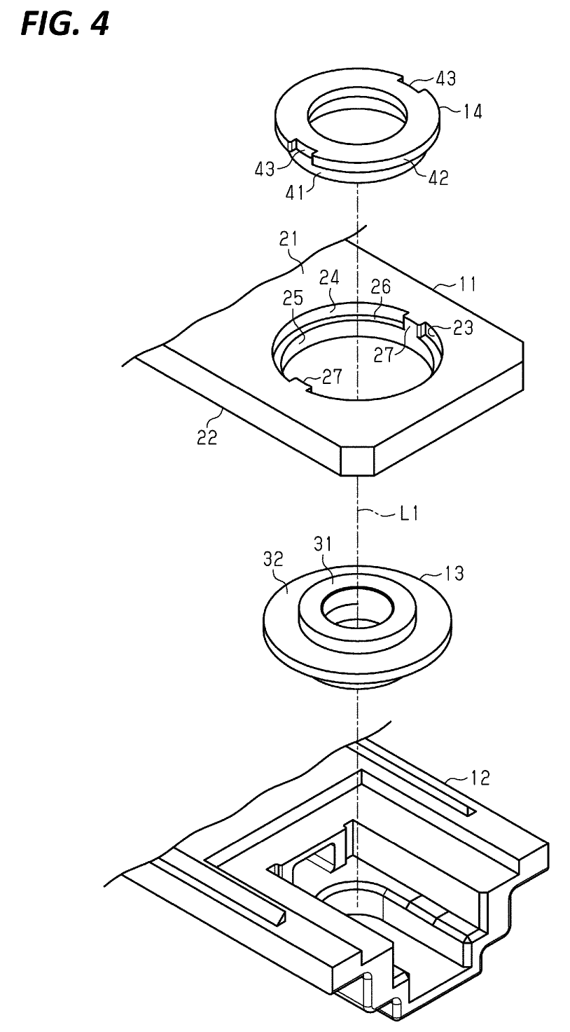

As shown in FIGS. 3 and 4, the busbar 11 includes a first surface 21, a second surface 22 on a side opposite to the first surface 21, and an insertion hole 23 through which the bolt B is to be inserted. The first surface 21 is a surface to be in contact with the counterpart terminal T. The second surface 22 is a surface to be in contact with the nut 13. The insertion hole 23 passes through the busbar 11 from the first surface 21 to the second surface 22 in the thickness direction. The insertion hole 23 has a substantially circular shape about an axis line L1. Note that in the description below, a direction extending along the axis line L1 and a direction orthogonal to the axis line L1 are referred to merely as an "axial direction" and an "axis-orthogonal direction", respectively. Also, in the description below, a circumferential direction about the axis line L1 and a radial direction about the axis line L1 are referred to merely as a "circumferential direction" and a "radial direction", respectively.

The insertion hole 23 of the busbar 11 includes a first inner diameter portion 24 and a second inner diameter portion 25 that are aligned in the axial direction, and a step portion 26 bordering on the first inner diameter portion 24 and the second inner diameter portion 25. The step portion 26 is provided at an intermediate position in the axial direction of the insertion hole 23. The first inner diameter portion 24 is provided in a range near the first surface 21 in the insertion hole 23 relative to the step portion 26. The second inner diameter portion 25 is provided in a range near the second surface 22 in the insertion hole 23 relative to the step portion 26, and has a diameter smaller than that of the first inner diameter portion 24.

### Configuration of Nut 13

The nut 13 includes a nut main body 31 to which the bolt B is to be screwed, and a first flange portion 32 extending outward in the radial direction from the nut main body 31. The nut 13 is made of, for example, a metal material. The nut main body 31 has a tubular shape extending in the axial direction. The inner circumferential surface of the nut main body 31 is provided with an internal screw to which the bolt B can be screwed.

The first flange portion 32 extends outward in the radial direction from the outer circumferential surface of the nut main body 31. The first flange portion 32 has, for example, a circular shape as viewed in the axial direction. In the upper surface in the axial direction of the first flange portion 32, a portion near the outer circumference serves as a bearing surface that is to be in contact with the second surface 22 of the busbar 11.

The collar 14 is fixed to the upper end portion of the nut main body 31. The nut 13 and the collar 14 are configured to be capable of being moved in the axis-orthogonal direction by being fixed to each other in the insertion hole 23 with the busbar 11 being sandwiched therebetween in the thickness direction.

### Configuration of Collar 14

The collar 14 has, for example, a cylindrical shape as a whole. The collar 14 is made of, for example, a metal, a synthetic resin, or the like. The collar 14 includes a fixation portion 41 to be fixed to the nut 13, and a second flange portion 42 extending outward in the radial from the fixation portion 41.

The fixation portion 41 of the collar 14 has a cylindrical shape. The fixation portion 41 is, for example, externally fitted and fixed to the upper end portion of the nut main body 31. The fixation portion 41 and the nut main body 31 are fixed to each other through, for example, screw-fitting. That is to say, an external screw is formed on the outer circumferential surface of the upper end portion of the nut main body 31, and the external screw of the nut main body 31 is screwed to an internal screw on the inner circumferential surface of the fixation portion 41. Thus, the nut 13 and the collar 14 are fixed to each other through the insertion hole 23 of the busbar 11. In the state in which the collar 14 is fixed to the nut 13, the collar 14 is disposed inside the insertion hole 23.

The second flange portion 42 of the collar 14 has, for example, a circular shape as viewed in the axial direction. The second flange portion 42 faces the first flange portion 32 in the axial direction. The outer diameter of the first flange portion 32 is set to be larger than the outer diameter of the second flange portion 42. In the state in which the collar 14 is fixed to the nut 13, the second flange portion 42 is disposed inside the first inner diameter portion 24. A clearance for allowing the movement of the collar 14 and the nut 13 in the axis-orthogonal direction is provided between the outer circumferential surface of the second flange portion 42 and the inner circumferential surface of the first inner diameter portion 24. The fixation portion 41 of the collar 14 is disposed inside the second inner diameter portion 25 of the insertion hole 23. A clearance for allowing the movement of the collar 14 and the nut 13 in the axis-orthogonal direction is provided between the outer circumferential surface of the fixation portion 41 and the inner circumferential surface of the second inner diameter portion 25.

A peripheral portion of the insertion hole 23 in the busbar 11 enters between the first flange portion 32 and the second flange portion 42. Specifically, the second inner diameter portion 25 of the insertion hole 23 enters between the first flange portion 32 and the second flange portion 42. That is to say, the nut 13 and the collar 14 are fixed to each other such that the second inner diameter portion 25 is sandwiched between the first flange portion 32 and the second flange portion 42 in the axial direction. Thus, the nut 13 and the collar 14 are attached to the insertion hole 23 so as to be capable of being moved in the axis-orthogonal direction. The dimension in the axial direction between the upper surface of the first flange portion 32 and the lower surface of the second flange portion 42 that face each other is set to be larger than the dimension in the axial direction of the second inner diameter portion 25. Thus, slight movement in the axial direction of the nut 13 and the collar 14 that are fixed to each other is allowed. The dimension in the axial direction between the upper surface of the first flange portion 32 and the upper surface of the second flange portion 42 is set to be smaller than the thickness of the busbar 11 between the first surface 21 and the second surface 22. Thus, in the state in which the busbar 11 and the counterpart terminal T are fastened to each other with the bolt B and the nut 13, the entire second flange portion 42 is located inside the first inner diameter portion 24 in the axial direction.

As shown in FIGS. 2 and 4, the second flange portion 42 of the collar 14 includes locking portions 43. The locking portions 43 each have, for example, a recessed shape that is recessed inward in the radial direction from the outer circumferential surface of the second flange portion 42. In the collar 14 of this embodiment, the second flange portion 42 includes, for example, a plurality of (two, in this embodiment) locking portions 43. The plurality of locking portions 43 are provided at equal angular intervals in the circumferential direction.

In the busbar 11, the first inner diameter portion 24 of the insertion hole 23 includes rotation restriction portions 27 that are locked to the locking portions 43 in the circumferential direction. The number of the rotation restriction portions 27 provided is the same as the number of the locking portions 43 of the collar 14. That is to say, the insertion hole 23 of this embodiment includes two rotation restriction portions 27. The rotation restriction portions 27 each protrude inward in the radial direction from the inner circumferential surface of the first inner diameter portion 24 and enter the recessed locking portions 43 of the second flange portion 42. Thus, the rotation of the collar 14 and the nut 13 about the axis line L1 is restricted.

### Functions of This Embodiment

The following describes the functions of this embodiment.

The nut 13 is fixed to the collar 14 and is thus attached to the insertion hole 23 of the busbar 11 so as to be capable of being moved in the axis-orthogonal direction. Thus, when the busbar 11 and the counterpart terminal T are fastened to each other with the bolt B, the manufacturing tolerances and the attachment tolerances in the axis-orthogonal direction can be absorbed due to the movement of the nut 13 in the axis-orthogonal direction. When the bolt B is screwed to the nut 13, the rotation restriction portions 27 of the insertion hole 23 that are locked to the locking portions 43 of the collar 14 prevent the rotation of the nut 13. This makes it possible to fasten the busbar 11 and the counterpart terminal T to each other with the bolt B and the nut 13.

### Effects of This Embodiment

The following describes the effects of this embodiment.

1 The terminal bases 10 includes the nut 13 for fastening the busbar 11 and the counterpart terminal T to each other together with the bolt B by the bolt B being screwed to the nut 13, and the tubular collar 14 that is fixed to the nut 13 and that is attached to the insertion hole 23 together with the nut 13. The nut 13 and the collar 14 are configured to be capable of being moved in the axis-orthogonal direction by being fixed to each other in the insertion hole 23 with the busbar 11 being sandwiched therebetween in the thickness direction. With this configuration, the movement of the nut 13 attached to the insertion hole 23 of the busbar 11 via the collar 14 in the axis-orthogonal direction is allowed. Accordingly, the manufacturing tolerances and the attachment tolerances can be absorbed due to the movement of the nut 13 in the axis-orthogonal direction, thus making it possible to suppress occurrence of poor attachment, that is, a failure to fasten the busbar 11 and the counterpart terminal T to each other with the bolt B.

2 The nut 13 includes the nut main body 31 to which the bolt B is to be screwed, and the first flange portion 32 extending outward in the radial direction from the nut main body 31. The collar 14 includes the fixation portion 41 to be fixed to the nut 13, and a second flange portion 42 that extends outward in the radial from the fixation portion 41 and that faces the first flange portion 32 in the axial direction. A portion of the busbar 11 enters between the first flange portion 32 and the second flange portion 42. With this configuration, the movement of the nut 13 in the axis-orthogonal direction is allowed, while dislodgment of the nut 13 from the insertion hole 23 can be prevented by the first flange portion 32 of the nut 13 and the second flange portion 42 of the collar 14.

3 The outer diameter of the first flange portion 32 is larger than the outer diameter of the second flange portion 42. With this configuration, the outer diameter of the second flange portion 42 of the collar 14 is reduced, while the overlap allowance of the nut 13 against the busbar 11 can be increased by increasing the outer diameter of the first flange portion 32 of the nut 13.

4 The busbar 11 includes the first surface 21 to be in contact with the counterpart terminal T, and the second surface 22 that is a surface on a side opposite to the first surface 21 and that is in contact with the nut 13. The insertion hole 23 of the busbar 11 passes through the busbar 11 from the first surface 21 to the second surface 22. The insertion hole 23 of the busbar 11 includes the step portion 26 provided at an intermediate position in the axial direction of the insertion hole 23, the first inner diameter portion 24 provided near the first surface 21 relative to the step portion 26, and the second inner diameter portion 25 that is provided near the second surface 22 relative to the step portion 26 and that has a diameter smaller than that of the first inner diameter portion 24. The second flange portion 42 of the collar 14 is disposed inside the first inner diameter portion 24. The second inner diameter portion 25 enters between the first flange portion 32 and the second flange portion 42. With this configuration, it is possible to achieve a configuration in which the collar 14 is disposed inside the insertion hole 23, while dislodgment of the nut 13 and the collar 14 from the insertion hole 23 is prevented.

5 In the state in which the busbar 11 and the counterpart terminal T are fastened to each other with the bolt B and the nut 13, the entire second flange portion 42 is located inside the first inner diameter portion 24 in the axial direction. With this configuration, the collar 14 does not protrude from the first surface 21 of the busbar 11 even in a state in which the busbar 11 and the counterpart terminal T are fastened to each other, thus making it possible to favorably fastening the busbar 11 and the counterpart terminal T to each other.

6 The collar 14 includes the locking portions 43. The insertion hole 23 of the busbar 11 includes the rotation restriction portions 27 that are locked to the locking portions 43 in the circumferential direction. With this configuration, the rotation of the collar 14 and the nut 13 can be suppressed during the fastening of the bolt B, thus making it possible to improve the attachability of the bolt B.

7 The nut 13 and the collar 14 are fixed to each other through screw-fitting. With this configuration, the nut 13 and the collar 14 can be easily fixed to each other through screw-fitting.

### Other Embodiments

The embodiment mentioned above can be implemented with modifications as follows. The embodiment mentioned above and the following modified examples can be implemented in combination with each other as long as they are technically compatible with each other.

Although the nut 13 and the collar 14 are fixed to each other through screw-fitting in the embodiment above, they may be fixed to each other through press-fitting instead of the screw-fitting. With this configuration, the nut 13 and the collar 14 can be easily fixed to each other through press-fitting. The nut 13 and the collar 14 may also be fixed to each other through crimping. With this configuration, the nut 13 and the collar 14 can be easily fixed to each other through crimping.

In the terminal base 10 of the embodiment above, the recess-protrusion relationship between the locking portions 43 of the collar 14 and the rotation restriction portions 27 of the insertion hole 23 may be inverted. That is to say, the locking portions 43 may have a protruding shape that protrudes outward in the radial direction from the outer circumferential surface of the second flange portion 42, and the rotation restriction portions 27 may have a recessed shape that is recessed outward in the radial direction from the outer circumferential surface of the first inner diameter portion 24.

In the embodiment above, the nut 13 may be configured to be locked to the insertion hole 23 in the circumferential direction.

In the embodiment above, the configuration in which the second inner diameter portion 25 of the insertion hole 23 enters between the first flange portion 32 and the second flange portion 42 is employed, and therefore, when the collar 14 is housed in the insertion hole 23, the upper surface of the collar 14 does not protrude from the first surface 21 of the busbar 11. However, there is no particular limitation to this configuration, and a configuration may also be employed in which, for example, the second flange portion 42 of the collar 14 comes into contact with the first surface 21 of the busbar 11. In this case, it is preferable to employ a configuration in which the counterpart terminal T does not interfere with the collar 14 by, for example, making the diameter of at least the lower end portion of the terminal-side insertion hole Ta larger than the outer diameter of the second flange portion 42.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A terminal base comprising: a plate-shaped busbar that includes an insertion hole through which a bolt is to be inserted and that is to be fastened and connected to a counterpart terminal with the bolt; a housing for holding the busbar; a nut for fastening the busbar and the counterpart terminal to each other together with the bolt by the bolt being screwed to the nut; and a tubular collar that is fixed to the nut and that is attached to the insertion hole together with the nut, wherein the nut and the collar are configured to be capable of being moved in an axis-orthogonal direction by being fixed to each other in the insertion hole with the busbar being sandwiched therebetween in a thickness direction.

2. The terminal base according to claim 1, wherein the nut includes a nut main body to which the bolt is to be screwed, and a first flange portion extending outward in a radial direction from the nut main body, the collar includes a fixation portion fixed to the nut, and a second flange portion that extends outward in the radial direction from the fixation portion and that faces the first flange portion in an axial direction, and a portion of the busbar enters between the first flange portion and the second flange portion.

3. The terminal base according to claim 2, an outer diameter of the first flange portion is larger than an outer diameter of the second flange portion.

4. The terminal base according to claim 2,wherein the busbar includes a first surface to be in contact with the counterpart terminal, and a second surface that is a surface on a side opposite to the first surface and that is in contact with the nut, the insertion hole passes through the busbar from the first surface to the second surface, the insertion hole includes a step portion provided at an intermediate position in an axial direction of the insertion hole, a first inner diameter portion provided near the first surface relative to the step portion, and the second inner diameter portion that is provided near the second surface relative to the step portion and that has a diameter smaller than that of the first inner diameter portion, the second flange portion is disposed inside the first inner diameter portion, and the second inner diameter portion enters between the first flange portion and the second flange portion.

5. The terminal base according to claim 4, wherein in a state in which the busbar and the counterpart terminal are fastened to each other with the bolt and the nut, the entire second flange portion is located inside the first inner diameter portion in an axial direction.

6. The terminal base according to claim 1, the collar includes a locking portion, and the insertion hole includes a rotation restriction portion locked to the locking portion in a circumferential direction.

7. The terminal base according to claim 1 wherein the nut and the collar are fixed to each other through screw-fitting.

8. The terminal base according to claim 1 wherein the nut and the collar are fixed to each other through press-fitting.
